(19) United States
(12) Patent Application Publication
(10) Pub. No.: US 2007/0073432 A1
(43) Pub. Date: Mar. 29, 2007

(54) SYSTEM AND METHOD FOR CAPTURING MANUFACTURING DATA AUTOMATICALLY

(75) Inventor: Zhi-Yong Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,107

(22) Filed: Jun. 23, 2006

(30) Foreign Application Priority Data
Jul. 21, 2005 (CN) 200510036131.6

(51) Int. Cl. G06F 19/00

(52) U.S. Cl. 700/108

(57) ABSTRACT

A method for capturing manufacturing data automatically includes the steps of: setting and storing data capturing parameters; initializing a host computer (1) and at least one data communication terminal (3); controlling the at least one data communication terminal to capture the manufacturing data from at least one corresponding workstation (5) according to the data capturing parameters; and receiving and storing the manufacturing data transmitted from the at least one data communication terminal. A system for capturing manufacturing data automatically is also disclosed.

### FIELD OF THE INVENTION

The present invention generally relates to systems and methods for supplying manufacturing services, and more particularly to a system and method for capturing manufacturing data automatically.

### DESCRIPTION OF RELATED ART

In production lines, manufacturing data are captured by preparing sheets of paper listing values and parameters categorized by apparatuses. Each apparatus is then placed in next to a corresponding apparatus. Manufacturing data such as histories, vacuum values, gas pressures, flow rates, film thickness values, foreign substance events and the like with respect to actually-processed products of each model name and lot number in a product processing apparatus for performing control are then captured manually, thereby maintaining product quality.

Manufacturing data are captured by a batch (a processing unit) by manually filling in the forms with: dates, chip names, lot numbers, and employee id when inputting products to an apparatus for processing; indicated values of each measuring instrument of the apparatus during processing; and film thickness values, the number of foreign substances, special remarks, and the like with respect to processed products.

Manufacturing data in conventional production lines are captured manually as described above. However, this causes problems in labor time wasted and operation errors including misreading, miswriting, and misinterpreting any out-of-spec values displayed.

What is needed, therefore, is a system and method that can supply manufacturing services automatically.

### SUMMARY OF INVENTION

A system for capturing manufacturing data automatically in accordance with a preferred embodiment is installed in a host computer and includes a setting module, an initializing module, a capturing module and an input/output module. The setting module is configured for setting data capturing parameters. The initializing module is configured for initializing the host computer and an external data communication terminal. The capturing module is configured for controlling the external data communication terminal to capture the manufacturing data from an external workstation according to the data capturing parameters. The input/output module is configured for inputting the data capturing parameters and the captured manufacturing data into an external server.

A computer-based method for capturing manufacturing data automatically in accordance with a preferred embodiment includes the steps of: setting and storing data capturing parameters; initializing a host computer and at least one data communication terminal; controlling the at least one data communication terminal to capture the manufacturing data from at least one corresponding workstation according to the data capturing parameters; and receiving and storing the manufacturing data transmitted from the at least one data communication terminal.

Other advantages and novel features of the present invention will become more apparent from the following detailed description of preferred embodiments when taken in conjunction with the accompanying drawings.

### BRIEF DESCRIPTION OF DRAWINGS

FIG. 1 is a schematic diagram of hardware configuration of a system for capturing manufacturing data automatically in accordance with a preferred embodiment;

FIG. 2 is a schematic diagram of main function modules of the host computer of FIG. 1;

FIG. 3 is a schematic diagram illustrating how the capturing module of FIG. 2 captures manufacturing data; and

FIG. 4 is a flowchart of a method for capturing manufacturing data automatically in accordance with a preferred embodiment.

### DETAILED DESCRIPTION

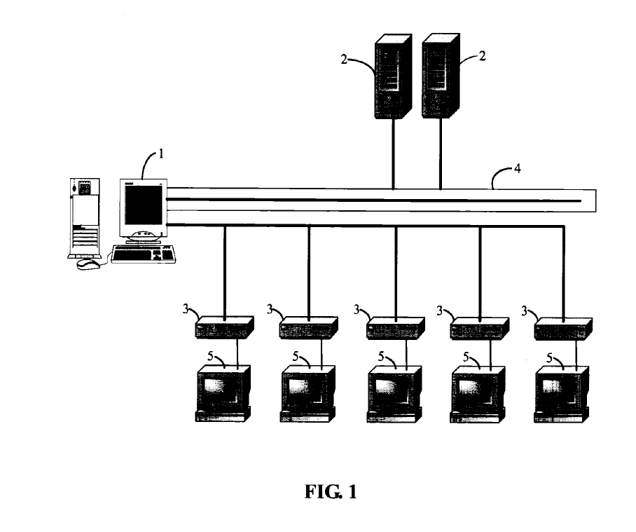

FIG. 1 is a schematic diagram of hardware configuration of a system for capturing manufacturing data automatically (hereinafter, “the system”) in accordance with a preferred embodiment. The system includes: a host computer 1 that provides a uniform management interface to a user via a data link of a network 4, at least one server 2 connected with the host computer 1 via a data link of the network 4, and at least one data communication terminal 3 connected with the host computer 1 via a data link and corresponding workstations 5. The host computer 1 is configured for setting data capturing parameters, initializing the servers 2 and the data communication terminals 3, controlling the data communication terminals 3 to capture manufacturing data of a production line(s), receiving and processing the manufacturing data, and inspecting work statuses of each workstation 5. The servers 2 are configured for storing the set data capturing parameters, captured manufacturing data, and inspected status data of the workstations 5. The data communication terminals 3 are configured for capturing manufacturing data of production lines through the workstations 5, and transmitting the captured manufacturing data and the inspected work status data of the workstations 5 to the host computer 1.

The network 4 can be an intranet, the Internet, or any other suitable type of communications link.

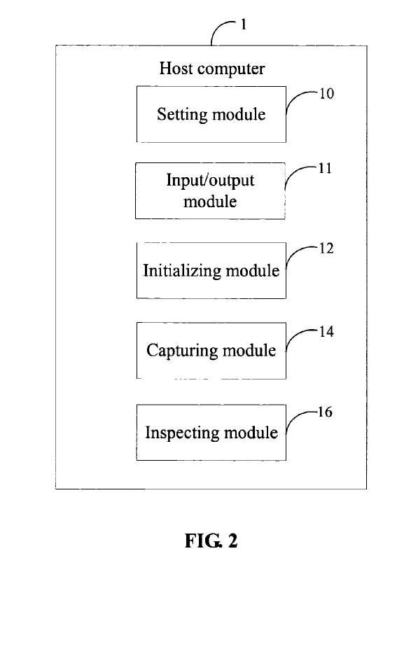

FIG. 2 is a schematic diagram of main function modules of the host computer 1. The host computer 1 typically includes a setting module 10, an input/output module 11, an initializing module 12, a capturing module 14, and an inspecting module 16.

The setting module 10 is configured for setting data capturing parameters. The data capturing parameters typically include: an entry password of the main function modules of the host computer 1, a type of each data communication terminal 3, a type of each workstation 5, types of work of each workstation 5, storing processes named “StoredProcedure”, and data of each workstation 5. The type of each workstation 5 denotes the working range of the workstation 5. The storing processes are different program segments stored in the servers 2, and correspond to different works between the host computer 1 and the servers 2. Data of a workstation 5 typically includes an identification and an address of the workstation 5.

The input/output module 11 is configured for inputting the data capturing parameters set by the setting module 10, captured manufacturing data of production lines, and inspected status data of each workstation 5 into the servers 2. The input/output module 11 is further configured for outputting a peculiar processing request through displays of the data communication terminals 3.

The initializing module 12 is configured for initializing the host computer 1 and the data communication terminals 3.

The capturing module 14 is configured for controlling the data communication terminals 3 to capture manufacturing data of production lines from the corresponding workstations 5 according to the data capturing parameters.

The inspecting module 16 is configured for inspecting work statuses of each workstation 5, and determining whether the workstation 5 is in good working condition. The inspecting module 16 is further configured for controlling the data communication terminals 3 to trigger alarm warnings when there are any malfunctions in a corresponding workstation 5, and also for pausing the corresponding workstation 5 of capturing manufacturing data until a user has eliminated any malfunctions of the workstation 5 according to the peculiar processing request outputted by the input/output module 11.

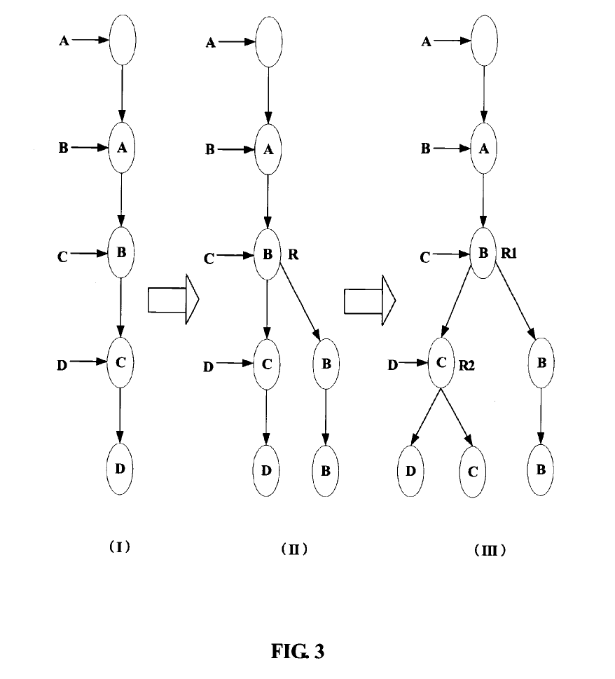

FIG. 3 is a schematic diagram illustrating how the capturing module 14 captures manufacturing data. The schematic diagram includes part (I), part (II), and part (III). Part (I) denotes a first technique, which is used for capturing manufacturing data of production lines without recording a previous manufacturing data. That is, a previous data B must be erased when a current data C is to be captured. Part (II) denotes a second technique, which is used for capturing and recording manufacturing data of production lines in a node “R”. That is, the previous data B is recorded when the current data C is captured in the node “R”, and the previous data B and the current data C are captured simultaneously. Part (III) denotes a third technique, which is used for capturing and recording manufacturing data of production lines in many nodes (only “R1” and “R2” shown). That is, the previous data B is recorded when the current data C is captured in the node “R1”, and the current data C is recorded when a new data D is captured in the node “R2”. That is, the previous data B, the current data C and the new data D are all captured. In the preferred embodiment, the capturing module 14 adopts the third technique.

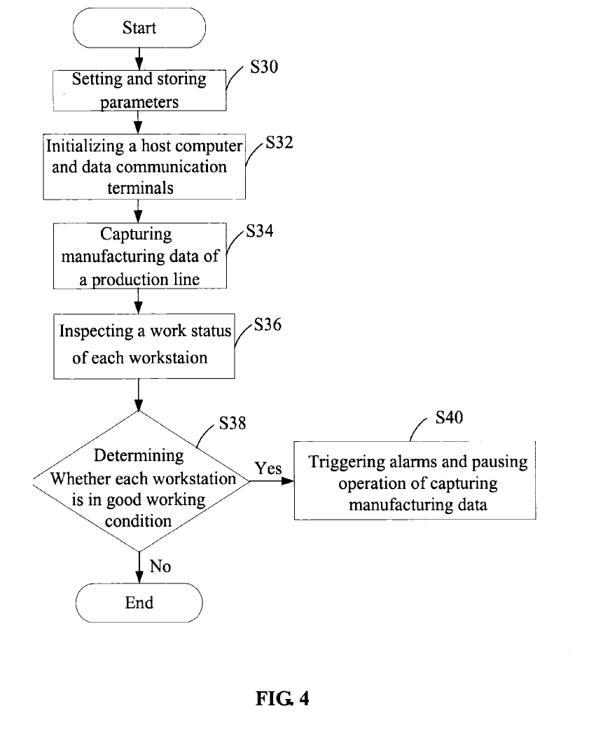

FIG. 4 is a flowchart of a method for capturing manufacturing data automatically in accordance with a preferred embodiment. If a user wants to capture and process manufacturing data of a production line, he/she may use the host computer 1 to control the servers 2 and the data communication terminals 3 for capturing and processing manufacturing data of the production line.

In step S30, the central processing unit (CPU) of the host computer 1 activates the setting module 10 and the input/output module 11. The setting module 10 sets data capturing parameters, the input/output module 11 inputs the data capturing parameters into the servers 2 that store the capturing parameters. The data capturing parameters typically include: an entry password to the main function modules of the host computer 1, a type of each data communication terminal 3, a type of each workstation 5, types of work of each workstation 5, storing processes named “StoredProcedure”, and data of each workstation 5.

In step S32, the CPU activates the initializing module 12. The initializing module 12 initializes the host computer 1 and the data communication terminals 3. In step S34, the CPU activates the capturing module 14. The capturing module 14 controls the data communication terminals 3 to capture manufacturing data of the production line(s) from the corresponding workstation 5 according to the data capturing parameters, the data communication terminals 3 transmits the captured manufacturing data to the host computer 1, and the input/output module 11 inputs the received manufacturing data into the servers 2 that store the received manufacturing data. In step S36, the CPU activates the inspecting module 16. The inspecting module 16 inspects work statuses of each workstation 5, and the input/output module 11 inputs inspected work status data of each workstation 5 into the servers 2 that store the work status data of each workstation 5.

In step S38, the inspecting module 16 determines whether any workstation 5 is in good working condition. If there is any malfunction in the corresponding workstation 5, in step S40, the inspecting module 16 controls the corresponding data communication terminals 3 to trigger alarm warnings, and the input/output module 11 outputs an peculiar processing request through the display of the data communication terminal 3 corresponding to the workstation 5, the inspecting module 16 pauses the workstation 5 of capturing manufacturing data until the malfunction of the corresponding workstation 5 has been eliminated according to the peculiar processing request by the user.

It should be emphasized that the above-described embodiments of the preferred embodiments, particularly, any “preferred” embodiments, are merely possible examples of implementations, merely set forth for a clear understanding of the principles of the invention. Many variations and modifications may be made to the above-described preferred embodiment(s) without departing substantially from the spirit and principles of the invention. All such modifications and variations are intended to be included herein within the scope of this disclosure and the above-described preferred embodiment(s) and protected by the following claims.

What is claimed is:

1. A system for capturing manufacturing data automatically, the system being installed in a host computer and the system comprising:
a setting module configured for setting data capturing parameters;
an initializing module configured for initializing the host computer and an external data communication terminal;
a capturing module configured for controlling the external data communication terminal to capture the manufacturing data from an external workstation according to the data capturing parameters; and
an input/output module configured for inputting the data capturing parameters and the captured manufacturing data into an external server.

2. The system as claimed in claim 1, further comprising:
an inspecting module configured for inspecting work statuses of the external workstation, and determining whether the external workstation is in a predetermined working condition.

3. The system as claimed in claim 2, wherein the inspecting module is further configured for controlling the external data communication terminal to trigger alarm warnings, and pausing the corresponding operation of capturing manufacturing data.

4. The system as claimed in claim 3, wherein the input/output module is further configured for outputting peculiar processing request through displays of the external data communication terminal.

5. A computer-based method for capturing manufacturing data automatically, the method comprising the steps of:
setting and storing data capturing parameters;
initializing a host computer and at least one data communication terminal;
controlling the at least one data communication terminal to capture manufacturing data from at least one corresponding workstation according to the data capturing parameters; and
receiving and storing the manufacturing data transmitted from the at least one data communication terminal.

6. The method as claimed in claim 5, further comprising the steps of:
inspecting a work status of each workstation;
determining whether the workstation is in a predetermined working condition;
controlling a corresponding data communication terminal to trigger alarm warnings if there is any malfunction in the workstation; and
pausing a corresponding operation of capturing manufacturing data.
